(19) United States
(12) Patent Application Publication
(10) Pub. No.: US 2011/0211001 A1
(43) Pub. Date: Sep. 1, 2011

(54) CONTROL APPARATUS AND LIQUID EJECTING APPARATUS

(75) Inventor: Haruhisa UEZAWA, Shiojiri-shi (JP)

(73) Assignee: SEIKO EPSON CORPORATION, Tokyo (JP)

(21) Appl. No.: 13/010,179

(22) Filed: Jan. 20, 2011

(30) Foreign Application Priority Data
Mar. 1, 2010 (JP) 2010-044791

(51) Int. Cl. B41J 29/38

(52) U.S. Cl. 347/10

(57) ABSTRACT

A control apparatus includes a discharge control unit, wherein the discharge control unit controls liquid so that, before a start of printing of which the printing is performed on a printing medium by ejecting a liquid, which is filled and heated within flow passages, from a nozzle opening, the liquid within the flow passages of the liquid ejecting head is discharged from the nozzle opening, and, after the liquid ejecting head is heated to a printing temperature by the heated liquid and the liquid ejecting head reaches the printing temperature, discharging of the liquid from the nozzle opening is stopped.

The entire disclosure of Japanese Patent Application No: 2010-044791, filed Mar. 1, 2010 are expressly incorporated by reference herein.

### BACKGROUND

1. Technical Field

The present invention relates to a control apparatus that controls a liquid ejecting head for ejecting liquid from a nozzle opening and a liquid ejecting apparatus that includes the control apparatus.

2. Related Art

As a representative example of the liquid ejecting head that ejects liquid droplets, there is an ink jet type recording head that ejects ink droplets. The ink jet type recording head, for example, includes a nozzle plate in which a nozzle is pierced and disposed, a flow passages forming substrate in which the liquid flow passages including a plurality of pressure generating chambers communicating with the nozzle are formed, and a pressure generating unit that is formed in one side of the flow passages forming substrate.

Recently, demand has increased for printing not only on a paper but also on plastic, glass or the like as a printing object. Since the ink absorption properties of such printing objects are low, high viscosity ink is used so as to reliably fix the ink to the printing object. Because the high viscosity ink has too high a viscosity at room temperature, the ink within the liquid flow passages is heated and the viscosity of the ink is lowered in the ink jet type recording head. The ink stably flows in the liquid flow passages as a result of the lowering of the viscosity of the ink so that good ejection characteristics of the ink are obtained (for example, see JP-A-2003-19790).

However, there is a problem that a heating unit such as heater that heats all flow passages within the recording head cannot be provided and the temperature of the overall recording head is biased even if the heating unit heats the recording head, so that a long heating time is needed to evenly heat the overall recording head to a desired temperature and the waiting time until the start of printing becomes long.

Also, there is a problem that when the temperature of the overall recording head is biased, since insufficiently warmed ink is ejected, high viscosity ink can not ejected with desired ejection characteristics, whereby the printing quality is varied and lowered.

These problems are not only present in the control apparatus that controls the ink jet type recording head but also in a control apparatus of a liquid ejecting head that ejects liquid other than ink.

### SUMMARY

An advantage of some aspects of the invention is that a control apparatus and a liquid ejecting apparatus are provided wherein the waiting time until the start of printing may be shortened and the variation of the printing quality may be suppressed.

According to an aspect of the invention, there is provided a control apparatus including a discharge control unit, wherein the discharge control unit controls liquid so that before a printing start of which the printing is performed on an printing medium by ejecting a liquid, which is filled and heated within flow passages, from a nozzle opening, the liquid within the flow passages of the liquid ejecting head is discharged from the nozzle opening, and after the liquid ejecting head is heated to a printing temperature by the heated liquid and the liquid ejecting head reaches the printing temperature, the discharging of the liquid from the nozzle opening is stopped.

According to the aspect of the invention, the liquid within the liquid ejecting head is ejected from the nozzle opening by the discharge control unit so that the overall head can be heated in a short time using the heated liquid. Furthermore, since a heating unit that heats only some of the liquid may be disposed without providing a heating unit that heats the overall head, so that the apparatus can be made compact.

It is preferable that the discharge control unit is disposed within the liquid ejecting head and a pressure generating unit that generates pressure change within the flow passages and ejects the liquid from the nozzle opening is driven, so that the liquid within the flow passages is discharged from the nozzle opening. Accordingly, the cost can be decreased without separately providing a unit that discharges the liquid from the nozzle opening.

It is preferable that the discharge control unit is driven with a driving waveform for which consumption of the liquid per unit time is smaller than that of the printing toward an printing medium with the pressure generating unit. Accordingly, the liquid meniscus of the nozzle opening is prevented from being destroyed and the liquid ejection can be performed normally in printing.

It is preferable that the discharge control unit controls a supply pump that is connected to the flow passages of the liquid ejecting head and supplies the liquid so that the liquid within the flow passages is discharged from the nozzle opening. Accordingly, the liquid can be reliably discharged from the nozzle opening by the supply pump.

It is preferable that the discharge control unit controls an absorbing unit that absorbs the liquid from the nozzle opening of the liquid ejecting head so that the liquid within the flow passages is discharged from the nozzle opening. Accordingly, the liquid can be reliably discharged from the nozzle opening by the absorbing unit.

According to another aspect of the invention, there is provided a liquid ejecting apparatus including: the control apparatus according to any one of the above described aspects; a liquid ejecting head that ejects the liquid from the nozzle opening; and a heating unit that heats the liquid flowing within the flow passages of the liquid ejecting head.

According to the aspect of the invention, the waiting time until the overall head reaches the printing temperature can be shortened and an apparatus that rapidly can start printing can be realized.

It is preferable that the heating unit is disposed in the liquid ejecting head. Accordingly, the liquid ejecting head can be directly heated and the liquid within the liquid ejecting head can be heated simultaneously by the heating unit.

It is preferable that the heating unit is disposed in a liquid storing section in which the liquid supplied to the liquid ejecting head is stored.

### BRIEF DESCRIPTION OF THE DRAWINGS

The invention will be described with reference to the accompanying drawings, wherein like numbers reference like elements.

FIG. 1 is a perspective view showing a schematic configuration of a recording apparatus according to a first embodiment.

FIG. 2 is a cross sectional view of a recording head according to the first embodiment.

FIG. 3 is a block diagram showing a control system of the recording apparatus according to the first embodiment.

FIG. 4 is a block diagram showing the control system of the recording apparatus according to a second embodiment.

FIG. 5 is a block diagram showing the control system of the recording apparatus according to a third embodiment.

FIGS. 6A to 6C are drawings showing a driving waveform according to the third embodiment.

### DESCRIPTION OF EXEMPLARY EMBODIMENTS

Hereinafter, the invention will be described in detail on the basis of the embodiments.

### First Embodiment

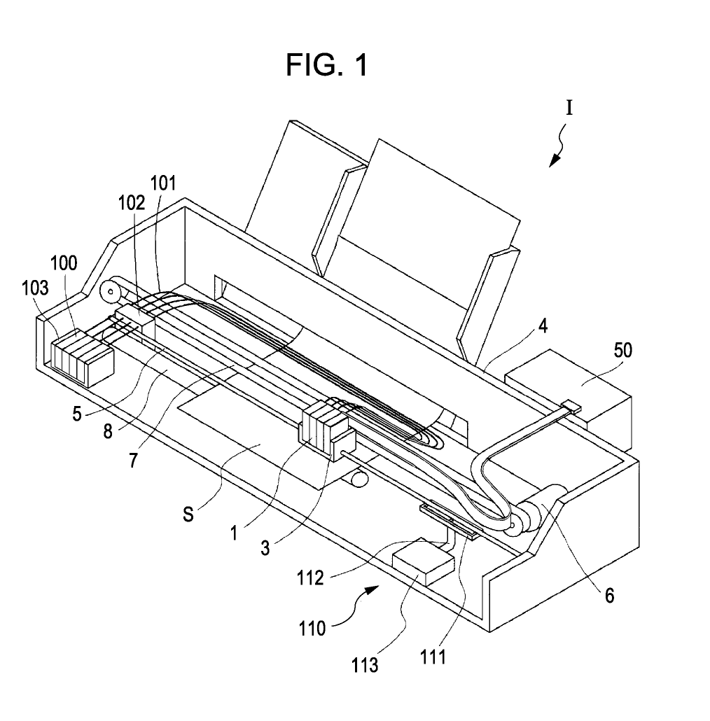

FIG. 1 is a perspective view showing a schematic configuration of an ink jet type recording apparatus that is an example of a liquid ejecting apparatus of the first embodiment of the invention.

As shown in FIG. 1, the ink jet type recording apparatus I that is an example of the liquid ejecting apparatus includes an ink jet type recording head 1.

The ink jet type recording head 1 (hereinafter, also referred to as the recording head 1) is loaded on a carriage 3 and the carriage 3 is disposed to be movable in an axial direction on a carriage shaft 5 that is attached in the apparatus main body 4.

A driving force of a driving motor 6 is delivered to the carriage 3 through a plurality of gears (not shown) and a timing belt 7 so that the carriage 3 on which the ink jet type recording head 1 is loaded moves along the carriage shaft 5. On the other hand, a platen 8 is disposed in the apparatus main body 4 along the carriage shaft 5 and a recording sheet S that is a recording medium such as a paper that is fed by a paper feeding roller (not shown) or the like is overlaid and transported to the platen 8.

Also, a liquid storing section 100, which is fixed in the apparatus main body 4 and stores ink, is connected through a supply pipe 101 such as a flexible tube or the like in the recording head 1. A supply pump 102 is attached in the middle of the supply pipe 101 and ink from the liquid storing section 100 is supplied to each of recording heads 1 by pressure of the supply pump 102. Also, the liquid storing section 100 is arranged in a position lower than the recording head 1 in vertical direction and the ink cannot be supplied to the recording head 1 from the liquid storing section 100 by water head difference. Thus, the ink in the liquid storing section 100 is supplied to the recording head 1 by the supply pump 102.

A first heating unit 103 such as a heater is disposed in the liquid storing section 100 and the ink in the liquid storing section 100 is heated by the first heating unit 103 and supplied to the recording head.

Furthermore, an absorbing unit 110 is disposed in a non-printing area of the ink jet type recording apparatus I wherein the absorbing unit 110 absorbs the ink, air bubbles or the like within the flow passage from the nozzle opening 13 of the recording head 1 that is described below in detail.

The absorbing unit 110 includes a cap member 111 that covers the nozzle opening 13 of the recording head 1 and an absorbing apparatus 113 such as a vacuum pump that is connected to the cap member 111 through a tube 112.

The absorbing unit 110 having the configuration as described above performs cleaning wherein the cap member 111 is brought into contact with an ejecting surface of the recording head 1, the absorbing apparatus 113 performs an absorbing operation whereby an interior of the cap member 111 is made to have negative pressure so that the ink within the flow passage is absorbed with the air bubbles from the nozzle opening 13. Also, in a case where the printing is in pause state, the cap member 111 seals the nozzle opening 13 so that the nozzle opening 13 may be prevented from drying.

A control apparatus 50 that is described below in detail and controls the operation of the ink jet type recording apparatus I is disposed in the ink jet type recording apparatus I.

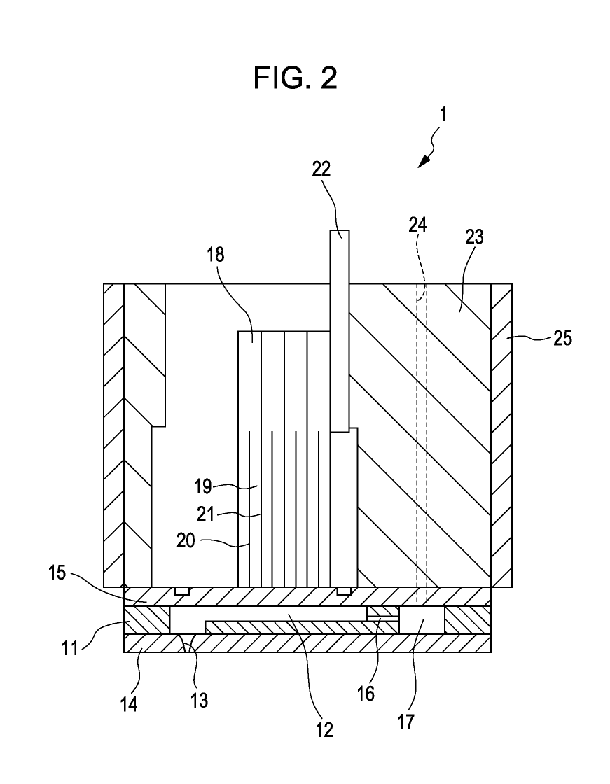

A description will be made regarding the ink jet type recording head 1 that is loaded on the ink jet type recording apparatus I. FIG. 2 is a cross sectional view showing the ink jet type recording head that is an example of the liquid ejecting head according to the first embodiment of the invention.

The ink jet type recording head 1 as shown in FIG. 2 has a vertical vibration type piezoelectric element as a pressure generating unit, a plurality of pressure generating chambers 12 is disposed parallel in the flow passage substrate 11, and both sides of the flow passage substrate 11 are sealed by a nozzle plate 14 having a nozzle opening 13 corresponding to each pressure generating chambers 12 and a vibration plate 15. Also, a manifold 17 is formed in the flow passage substrate 11 and the liquid storing section is connected to the manifold 17 that becomes a common ink chamber of the plurality of pressure generating chambers 12 which communicate with the manifold 17 through the ink supply openings 16, respectively.

On the other hand, at a side opposite the pressure generating chamber 12 in the vibration plate 15, a tip end of the piezoelectric element 18 is brought into contact and disposed respectively with areas corresponding to each of the pressure generating chambers 12. These piezoelectric elements 18 vertically alternatively laminate a piezoelectric material 19 and electrode forming materials 20 and 21 in a sandwich shape. An inactive area that does not contribute to the vibration is fixed to a fixed substrate 22. Also, the fixed substrate 22, the vibration plate 15, the flow passage substrate 11 and the nozzle plate 14 are integrally formed by a head case 23.

A liquid supply passage 24 which is connected to the supply pipe 101 connected to the liquid storing section 100 and connected to the manifold 17 is disposed in the head case 23. The ink from the liquid storing section 100 is supplied to the manifold 17 through the liquid supply passage 24 and distributed to each of the pressure generating chambers 12 through the ink supply opening 16. In practice, a voltage is applied to the piezoelectric element 18 so that the piezoelectric element 18 is contracted. Thus, the vibration plate 15 is deformed (drawn up to the upper direction in the drawing) with the piezoelectric element 18 so that a volume of the pressure-generating chamber 12 is increased and the ink is drawn into the pressure-generating chamber 12. After the ink is filled in the interior of the pressure generating chamber 12 until the nozzle opening 13 is reached, when the voltage that is applied to the electrode forming materials 20 and 21 of the piezoelectric element 18 is stopped according to a recording signal from a recording head driving circuit, the piezoelectric element 18 is expanded and returned to the original state. Accordingly, the vibration plate 15 is also displaced and returned to the original state so that the pressure-generating chamber 12 is contracted, an interior pressure is increased and the ink droplets are ejected from the nozzle opening 13. In other words, in the embodiment, as the pressure-generating unit that generates a pressure change in the pressure-generating chamber 12, the vertical vibration type piezoelectric element 18 is disposed.

A second heating unit 25 such as an electric heater that heats the ink passing through the liquid supply passage 24 that is disposed within the head case 23 is disposed at an outer periphery of the head case 23. The second heating unit 25 heats the ink that passes through within the liquid supply passage 24 of the head case 23 so that the heated ink is supplied to the manifold 17. In the embodiment, the first heating unit 103 is also disposed in the liquid storing section 100 and the ink that is stored in the liquid storing section 100 is heated. However, when the ink is supplied to the recording head 1 from the liquid storing section 100 through the supply pipe 101, there is a concern that that the ink which has been heated will cool whereby the temperature of the ink which is ejected from recording head 1 will be lowered. In the embodiment, the second heating unit 25 of the recording head 1 reheats the ink that has been heated in the liquid storing section 100 and keeps the ink warm so that the ink which is always heated to be constant is ejected from the recording head 1.

In the above-described embodiment, the heating units (the first heating unit 103 and the second heating unit 25) are disposed in both of the liquid storing section 100 and the recording head 1; however, the invention is not specifically limited thereto. For example, the heating units may be disposed either in the liquid storing section 100 or the recording head 1. Specifically, in the embodiment, even in a case in which only the first heating unit 103 is disposed in the liquid storing section 100, since the ink within the flow passage of the recording head 1 is discharged from the nozzle opening 13 before the printing is started, the overall recording head 1 can be heated to a desired temperature in a short time by the ink that is heated at the liquid storing section 100.

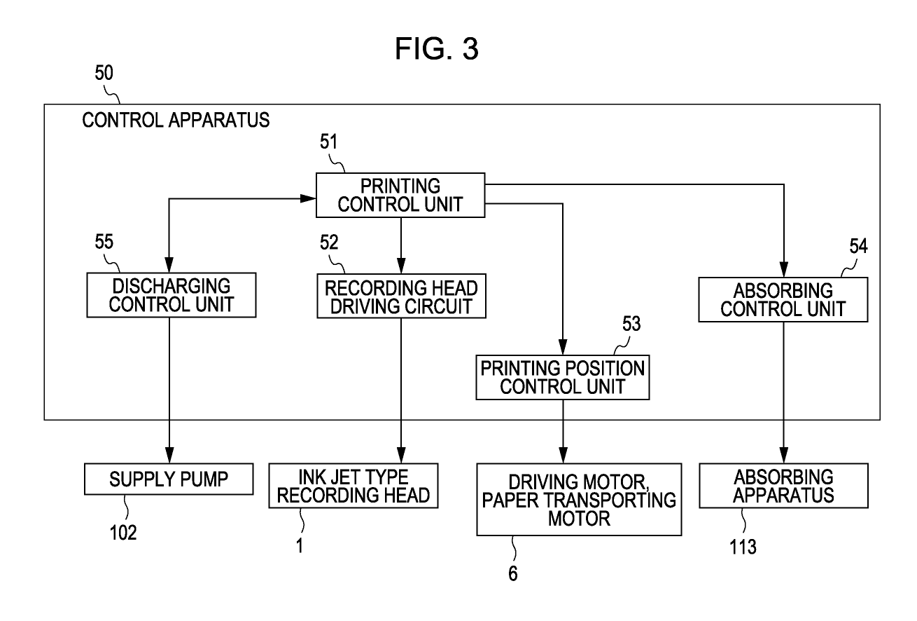

Hereinafter, description will be made regarding the control apparatus 50 that controls the ink jet type recording apparatus. FIG. 3 is a block diagram showing a control system of the recording apparatus of the first embodiment of the invention.

As shown in FIG. 3, the ink jet type recording apparatus I includes the recording head 1 that is a mechanical section performing practical printing, the absorbing unit 110 (see FIG. 1) that absorbs the ink from the nozzle opening 13 of the recording head 1 and the control apparatus 50 that controls the operation of the recording head 1 and the absorbing unit 110.

The control apparatus 50 includes a printing control unit 51, a recording head driving circuit 52, a printing position control unit 53, an absorbing control unit 54 and a discharging control unit 55.

The printing control unit 51 controls the printing operation of the recording head 1, for example, a driving pulse is applied to the piezoelectric element 18 through the recording head driving circuit 52 according to the input of the printing signal so that the ink is ejected from the recording head 1.

The printing position control unit 53 performs positioning of the main scanning direction and a sub scanning direction during the printing of the recording head 1, during the capping and during the discharging operation. Specifically, the printing position control unit 53 drives the driving motor 6 and moves the carriage 3 to the main scanning direction so that the positioning of the main scanning direction of the recording head 1 is performed. Also, the printing position control unit 53 drives a paper transporting motor (not shown in FIG. 1), rotates the platen 8 and moves the recording sheet S to the sub scanning direction so as to perform the positioning of the sub scanning direction of the recording head 1 with respect to the recording sheet S. Thus, the printing position control unit 53 moves the carriage 3 on which the recording head 1 is loaded in main scanning direction and simultaneously moves the recording sheet S in the sub scanning direction during printing. The carriage 3 on which the recording head 1 is loaded moves to the absorbing unit 110 side that is disposed in the non-printing area, during capping such as during a printing stop or during a cleaning operation.

The absorbing control unit 54 controls the absorbing operation of the absorbing unit 110. In other words, the absorbing control unit 54 operates the absorbing apparatus 113 of the absorbing unit 110 at the predetermined timing so that the absorbing operation which absorbs the ink in the vicinity of the nozzle opening 13 of the recording head 1 is performed by the absorbing unit 110. Specifically, the absorbing control unit 54 moves the recording head 1 to a position facing the cap member 111 through the printing position control unit 53, the recording head 1 is capped by the cap member 111 and the absorbing apparatus 113 is driven so that the absorbing operation is performed.

The discharging control unit 55 performs control so as to discharge the ink within the flow passage of the recording head 1 from the nozzle opening 13 at the predetermined timing. In the embodiment, the discharging control unit 55 controls the operation of the supply pump 102 that supplies the ink to the recording head 1 from the liquid storing section 100 and the ink within the flow passage is discharged from the nozzle opening 13.

Specifically, the discharging control unit 55 drives the supply pump 102 and supplies the ink to the recording head 1 from the liquid storing section 100 when inputting the power supply, when starting printing or the like for the ink jet type recording apparatus I. Also, the discharging control unit 55 stops the supply pump 102 and stops the ink supply to the recording head 1 from the liquid storing section 100 during the cutting of the power supply, during the stopping of printing or the like.

Thus, the discharging control unit 55 performs control such that the supply pump 102 changes the ink supply amount at the predetermined timing. In other words, the discharging control unit 55 discharges the ink from the nozzle opening 13 wherein a pressure that supplies the ink by the supply pump 102 is higher than that of the usual printing and a meniscus of the ink of the nozzle opening 13 is destroyed when inputting the power supply, when starting printing or the like for the ink jet type recording apparatus I.

When inputting the power supply, when starting printing or the like for the ink jet type recording apparatus I, heating is performed by the first heating unit 103 and the second heating unit 25. At this time, the first heating unit 103 is disposed in the liquid storing section 100 so that the recording head 1 cannot be directly heated; and the second heating unit 25 is disposed in the head case 23 so that the temperature of the overall recording head 1 is biased. Accordingly, long heating time is needed to heat the overall recording head in desired temperature without biasing, whereby the waiting time to start printing becomes long. Also, when the temperature of the overall recording head 1 is varied, the insufficiently warmed ink is ejected, so that high viscosity ink cannot be ejected with the desired ejection characteristics, the printing quality is varied and then the printing quality is lowered.

Accordingly, when the temperature of the overall recording head 1 is biased during the inputting of the power supply, during the starting of printing or the like for the ink jet type recording apparatus I, the discharging control unit 55 controls the supply pump 102 so that the ink within the flow passage of the recording head 1 is discharged from the nozzle opening 13. In other words, because the second heating unit 25 is disposed in the head case 23, the ink within the liquid supply passage 24 that is the flow passage in the vicinity of the second heating unit 25 is relatively quickly warmed. Thus, the ink within the flow passage of the recording head 1 is discharged from the nozzle opening 13 so that the ink that is warmed at the liquid supply passage 24 is filled in the manifold 17 or the pressure generating chamber 12 that are located lower than the liquid supply passage 24. Also, the constituent members (for example, the flow passage substrate 11, the nozzle plate 14 or the like) in which the second heating unit 25 of the recording head 1 is not disposed are warmed so that the overall recording head 1 can be heated to a desired temperature in a short time. Accordingly, the overall recording head 1 is heated to the desired temperature, the printing can be started in the state where the ink within the flow passage of the recording head 1 is heated to the desired temperature, so that the ink that has the desired temperature can be ejected with preferable ejection characteristics and a highly precise printing material can be obtained. In other words, since the ink is heated while being discharged from the nozzle opening 13, the time (practical waiting time to start printing) taken for the overall recording head 1 to reach the desired temperature when inputting the power supply, when starting of printing or the like can be shortened.

In other words, it is also considered that the second heating unit 25 heats the ink within the liquid supply passage 24 and the ink that has been heated is filled within the pressure generating chamber 12 so that the printing is performed; however, when the temperature of the flow passage substrate 11, the nozzle plate 14 or the like that constitute the recording head 1 is lower than that of the ink, a heat exchange is performed at the time the heated ink is filled in the pressure generating chamber 12 and the temperature of the ink is lowered, so that the printing cannot be started. Accordingly, in a case where the ink having a desired temperature is to be ejected, it is necessary to heat the overall recording head 1 to the desired temperature.

Also, the ink that is discharged from the nozzle opening 13 by the supply pump 102 may be received for example, in the cap member 111. Thus, the discharging control unit 55 controls the absorbing apparatus 113 and performs the discharging operation, and may control the printing position control unit 53, the absorbing control unit 54 or the like simultaneously. When the ink that is ejected from the nozzle opening 13 is to be returned to the liquid storing section 100, the ink is prevented from being wastefully consumed and the ink that is heated by the first heating unit 103 can be supplied to the recording head 1.

In the embodiment, the second heating unit 25 is disposed in the recording head 1 and the overall recording head 1 is heated by the second heating unit 25; however, because the ink within the flow passages of the recording head 1 is discharged from the nozzle opening 13, the overall recording head 1 can even be heated simply by the first heating unit 103 that is disposed in the liquid storing section 100.

Also, the time (the ink amount) during which the liquid within the flow passages is discharged from the nozzle opening 13 by the discharging control unit 55 is not specifically limited, for example, a temperature sensor may be disposed in a position away from the second heating unit 25 of the recording head 1 and the ink may be discharged from the nozzle opening 13 until the recording head 1 reaches the desired temperature. Of course, the time (the ink amount) during which the ink is discharged from the nozzle opening 13 is not limited to the above described method, for example, a temperature sensor that obtains the outside air temperature of the ink jet type recording apparatus I may be disposed and the temperature of the recording head 1 may be assumed according to the outside air temperature that is obtained by the temperature sensor and the lapsed time from the end of the prior printing so that the ink amount which is discharged from the nozzle opening 13 may also be determined. In other words, the ink amount that is discharged from the nozzle opening 13 may be defined by the time during which the supply pump 102 is driven for the discharge according to the ink supply amount by the supply pump 102, the ink amount within the flow passages of the recording head 1 or the like.

Furthermore, the timing in which the ink within the recording head 1 is discharged from the nozzle opening 13 by the discharge control unit 55 is not specifically limited; however, for example, there may be cases where the printing is not performed for more than a predetermined period such as during the inputting of the power supply, during the starting of printing. Thus, for example, a timing unit for measuring the printing stop time is disposed, and in a case where the printing stop time that is measured by the timing unit is more than a predetermined time, the ink within the recording head 1 may be discharged from the nozzle opening 13 by the discharge control unit 55.

If the overall recording head 1 is heated to the printing temperature by the discharge control unit 55 and the first and the second heating units 103 and 25, after the discharge of the ink from the nozzle opening 13 is stopped by the discharge control unit 55, the printing is started by the signal from the printing control unit 51. The printing temperature is the temperature at which the ink having the desired temperature can be ejected without the temperature of the ink that is heated and supplied to the pressure-generating chamber 12 being lowered. For example, when the temperature that is the same as the heated ink temperature is the printing temperature and the overall recording head 1 is heated to the printing temperature, the heated ink is not cooled by the members that constitute the recording head 1; however, the temperature of the recording head 1 depends on the outside environmental temperature, so that in practice the temperature of the vicinity of the liquid flow passages of the recording head 1 may be the same as that of the heated ink.

As described above, the supply pump 102 is controlled by the discharge control unit 55 during the inputting of the power supply, during the starting of printing or the like, and the ink within the flow passages is discharged from the nozzle opening 13 so that the overall recording head 1 can be heated to the desired temperature in a short time and the waiting time until the printing is started can be shortened.

### Second Embodiment

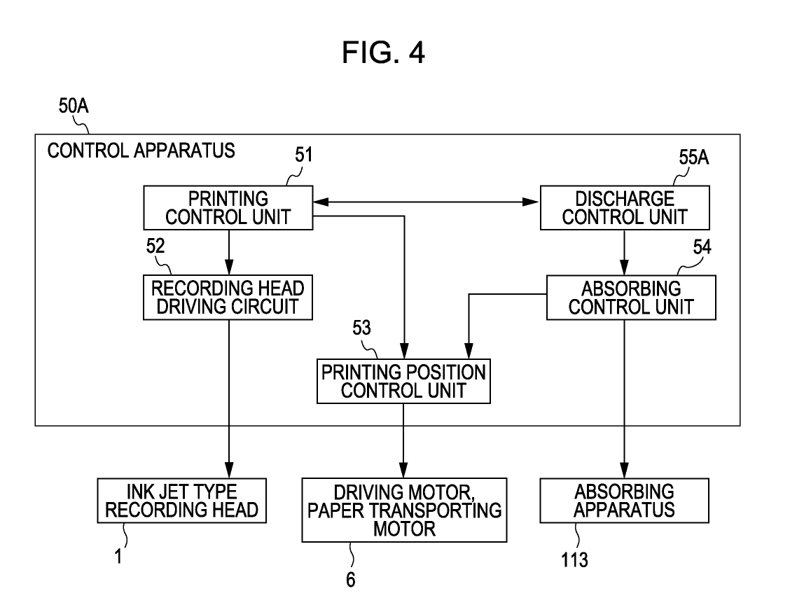

FIG. 4 is a block diagram schematically showing a configuration of a control apparatus according to a second embodiment of the invention. The constituent members similar to the first embodiment described above are given similar reference numbers thereof, and description thereof is omitted.

As shown in FIG. 4, a control apparatus 50A of the embodiment includes the printing control unit 51, the recording head driving circuit 52, the printing position control unit 53, the absorbing control unit 54 and a discharge control unit 55A.

The discharge control unit 55A performs control in which the absorbing operation is performed in the absorbing control unit 54 at a predetermined timing. In other words, the discharge control unit 55A performs the control of the absorbing apparatus 113 to the absorbing control unit 54 at the predetermined timing and the ink is absorbed from the nozzle opening 13 so that the ink within the flow passages is discharged.

The timing at which the discharge control unit 55A performs the discharging operation is also during the inputting of the power supply, during the starting of printing or the like, the same as that of the first embodiment.

As described above, in the embodiment, the discharge control unit 55A controls the absorbing control unit 54 and the absorbing control unit 54 controls the absorbing apparatus 113 so that the ink within the flow passages of the recording head 1 may be also discharged from the nozzle opening 13. Of course, the control by the discharge control unit 55A of the above-described first embodiment, in other words, the discharge of the ink by the supply pump 102; and the discharge of the ink by the absorbing unit 110 of the embodiment may be performed simultaneously. Also, in the embodiment, the discharge control unit 55A and the absorbing control unit 54 are disclosed; however, because the functions thereof are substantially similar to each other, only the absorbing control unit 54 having the function of the discharge control unit 55A may be disposed.

### Third Embodiment

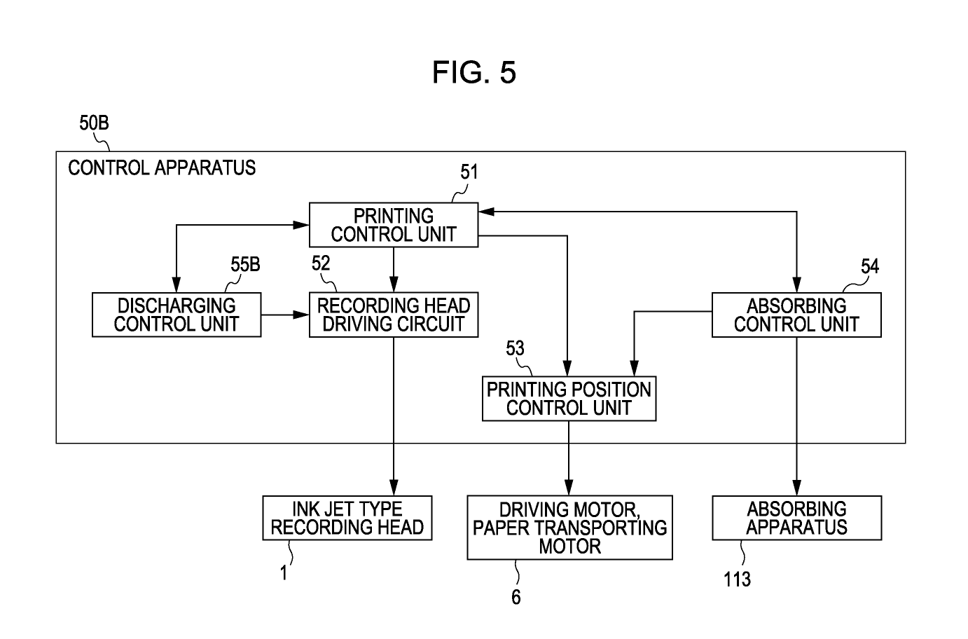

FIG. 5 is a block diagram schematically showing a configuration of the control apparatus according to a third embodiment of the invention. The constituent members similar to the first embodiment described above are given similar reference numbers thereof, and description thereof is omitted.

As shown in FIG. 5, the control apparatus 50B of the embodiment includes the printing control unit 51, the recording head driving circuit 52, the printing position control unit 53, the absorbing control unit 54 and a discharge control unit 55B.

The discharge control unit 55B of the embodiment drives the piezoelectric element 18 that is the pressure generating unit of the recording head 1 and discharges the ink within the flow passages from the nozzle opening 13. Here, the ink within the flow passages being discharged from the nozzle opening 13 is different from the ink being ejected to the recording sheet S such as in printing, and means for example, that the ink is ejected (discharged) toward a cap member 111 that is disposed in a home position.

When the piezoelectric element 18 is driven by the discharge control unit 55B and the ink is discharged from the nozzle opening 13, the temperature of the ink within the pressure generating chamber 12 is low and the viscosity is high, so that the failure of the ink ejection is generated and there is a concern that the ink meniscus of the nozzle opening 13 may be destroyed. Thus, when the ink is discharged from the nozzle opening 13 by the discharge control unit 55B, the piezoelectric element 18 is preferably driven with a driving waveform for which the ink consumption amount per unit time is smaller than that of the usual printing (the ink is ejected to the recording sheet S).

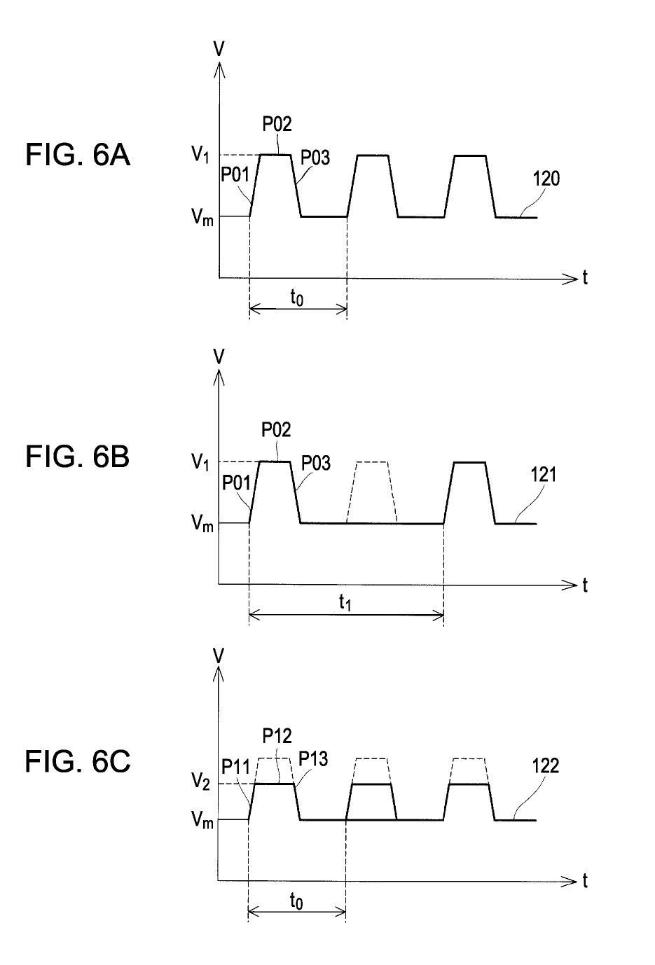

Hereinafter, a description will be made regarding the driving waveform that is outputted from the recording head driving circuit of the embodiment. FIGS. 6A to 6C are drawings showing driving waveforms of the driving signal.

The driving waveform that is inputted to the piezoelectric element 18 is applied to an individual electrode using a common electrode as the reference electric potential (0 V in the embodiment).

As shown in FIG. 6A, the driving waveform 120 of the driving signal that drives the piezoelectric element 18 in typical printing includes a first expansion element P01 that is raised from the state where a middle electric potential Vm is maintained at the first electric potential V1, a first hold element P02 that maintains the first electric potential V1 at a constant time, and a first contraction element P03 that drops the first electric potential V1 to the middle electric potential Vm. Thus, when the driving waveform 120 is supplied to the piezoelectric element 18, the piezoelectric element 18 is deformed by the first expansion element P01 toward a direction in which the volume of the pressure generating chamber 12 is expanded, the meniscus within the nozzle opening 13 is drawn in to the pressure generating chamber 12 side, and simultaneously the ink is supplied to the pressure generating chamber 12 from the manifold 17 side. Thus, the expansion state of the pressure-generating chamber 12 is maintained at the first hold element P02. Next, the first contraction element P03 is supplied so that the piezoelectric element 18 is expanded. Accordingly, the pressure generating chamber 12 is rapidly contracted to a volume corresponding to the middle electric potential Vm from the expanded volume so that the ink within the pressure generating chamber 12 is pressurized and the ink droplet is ejected from the nozzle opening 13. Also, the driving waveform including the first expansion element P01, the first hold element P02 and the first contraction element P03 is repeatedly generated in the constant period t₀ and the piezoelectric element 18 is selectively applied at the predetermined timing.

Meanwhile, the driving waveform 121 that is applied to the piezoelectric element 18 by the discharge control unit 55B as shown in FIG. 6B, for example, the driving waveform 121 having the first expansion element P01, the first hold element P02 and the first contraction element P03 is repeatedly applied to the piezoelectric element 18 at a period t₁ that is one time the period t₀ of the driving waveform 120 during the printing operation. When the piezoelectric element 18 is driven with the driving waveform 121, after the ink droplet is ejected, because the time until the next ink droplet is ejected becomes long, even if the viscosity of the ink is high, the ink can be sufficiently filled from the manifold 17 to each of the pressure generating chambers 12. In other words, when the period t₀ is short such as the driving waveform 120, the time until the next ink droplet is ejected is short, and in the case of high viscosity ink, the ink is insufficiently supplied to the pressure-generating chamber 12 from the manifold 17. When the piezoelectric element 18 is driven in the state where insufficient supply of the ink is generated, the meniscus of the nozzle opening 13 is strongly operated to a direction drawn within the pressure generating chamber 12 so that the meniscus of the ink of the nozzle opening 13 is to be destroyed. Therefore, when the piezoelectric element 18 is driven by the driving waveform 121 of the relatively long period t₁ as shown in FIG. 6B, the meniscus of the ink of the nozzle opening 13 is prevented from being destroyed so that the dot can be prevented from being missing due to the ink ejection failure in an actual printing operation.

A driving waveform 122 that is applied to the piezoelectric element 18 by the discharge control unit 55B includes as shown in FIG. 6C, for example, a second expansion element P11 that is raised from the middle electric potential Vm to the second electric potential V2 that is lower than the first electric potential V1, a second hold element P12 that maintains the second electric potential V2 at a constant time, and a second contraction element P13 that drops the second electric potential V2 to the middle electric potential Vm.

In the driving waveform 122, a voltage is applied to the piezoelectric element 18 that is lower than a voltage (the first electric potential V1−the middle electric potential Vm) that is applied to the piezoelectric element 18 during typical printing, so that the volume change that expands or contracts the pressure-generating chamber 12 can be small. Thus, failure to supply the high viscosity ink toward the pressure-generating chamber 12 is prevented and the meniscus of the nozzle opening 13 can be prevented from being destroyed.

The printing control unit 51 drives the piezoelectric element 18 using the driving waveform 121 or 122, and the ink within the flow passages is discharged from the nozzle opening 13 so that the ink that is heated by the first and the second heating units 103 and 25 is filled until it reaches the nozzle opening 13, and the overall recording head 1 can be heated in a short time. Thus, the same as the first embodiment, after the overall recording head 1 is heated, the printing is started so that the ink that is heated to the desired temperature is ejected with the desired ejection characteristics and the printing can be performed.

As described above, in the embodiment, the discharge control unit 55B drives the piezoelectric element 18 and then the ink within the flow passages is ejected from the nozzle opening 13. Accordingly, the overall recording head 1 can be heated to the desired temperature in a short time by the ink that is heated according to the first and the second heating units 103 and 25, and the waiting time until the start of the printing can be shortened. Of course, even in the embodiment, the heating units 103 and 25 may be disposed in at least one of the liquid storing section 100 and the recording head 1.

Also, in the embodiment, the discharge control unit 55B ejects the ink from the nozzle opening 13 by driving the piezoelectric element 18, but the invention is not specifically limited thereto. It may be assembled under the control of one of the supply pump 102 of the above-described first embodiment and the absorbing unit 110 of the second embodiment or both of them.

### Other Embodiment

As stated above, each of the embodiments of the invention is described; however, the basic configuration of the invention is not limited to the above description.

For example, as the pressure generating unit that generates the pressure change in the flow passages (the pressure generating chamber) in each of the above-described embodiments, the vertical vibration type piezoelectric elements 18 that alternatively laminate the piezoelectric material 19 and the electrode forming materials 20 and 21 and extend and contract them in the axial direction are disclosed; however, the pressure generating unit is not specifically limited thereto, and a horizontal vibration type piezoelectric element may be used wherein the piezoelectric material 19 and the electrode forming materials 20 and 21 are alternatively laminated and one end of the laminating direction is brought into contact with the vibration plate 15.

Also, as the pressure generating unit, for example, a thin film type piezoelectric element may be used wherein the thin film type piezoelectric element is formed of a bottom electrode, a piezoelectric body layer formed of the piezoelectric material and a top electrode by a film deposition and lithography method, and a thick film type piezoelectric element may be used wherein the thick film type piezoelectric element is formed by a method in which a green sheet is attached or the like. Also, as the pressure generating unit, a unit may be used wherein a heating element is arranged within the pressure generating chamber and the liquid droplet is ejected from the nozzle opening by a bubble that is generated by the heat of the heat generating element, or a unit may be used wherein static electricity is generated between the vibration plate and the electrode and the vibration plate is deformed by the static electricity force so that the liquid droplet is ejected from the nozzle opening.

Furthermore, in the above-described ink jet type recording apparatus I, the example in which the ink jet type recording head 1 is loaded on the carriage 3 and moves in the main scanning direction is disclosed; however, the invention is not specifically limited thereto, for example, a so-called line type recording apparatus may be also applied to the invention wherein the ink jet type recording head 1 is fixed, the recording sheet S such as paper or the like is only moved in sub scanning direction and then the printing is performed.

Further as described above, in each of the embodiments, as the example of the liquid ejecting head, the description was made regarding the ink jet type recording head, and as the example of the liquid ejecting apparatus, the description was made regarding the ink jet type recording apparatus; however, the invention widely relates to liquid ejecting heads and liquid ejecting apparatuses in general. Of course the invention may be applied to a liquid ejecting head or liquid ejecting apparatus that ejects liquid other than ink. As other liquid ejecting heads, for example, all kinds of recording heads that are used in the image recording apparatuses such as a printer, a color material ejecting head that is used for manufacturing a color filter such as a liquid crystal display or the like, an electrode material ejecting head that is used for forming an electrode of an organic EL display, a FED (an electric field emitting display) or the like, a bio-organic matter ejecting head that is used for manufacturing a bio-chip, or the like, may be exemplified. The invention may be also applied to a liquid ejecting apparatus that includes such liquid ejecting heads.

What is claimed is:

1. A control apparatus comprising a discharge control unit,
wherein the discharge control unit controls liquid so that, before a start of printing of which the printing is performed on a printing medium by ejecting a liquid, which is filled and heated within flow passages, from a nozzle opening, the liquid within the flow passages of the liquid ejecting head is discharged from the nozzle opening, and, after the liquid ejecting head is heated to a printing temperature by the heated liquid and the liquid ejecting head reaches the printing temperature, discharging of the liquid from the nozzle opening is stopped.

2. The control apparatus according to claim 1, wherein the discharge control unit is disposed within the liquid ejecting head and a pressure generating unit that generates pressure change within the flow passages and ejects the liquid from the nozzle opening is driven, so that the liquid within the flow passages is discharged from the nozzle opening.

3. The control apparatus according to claim 2, wherein the discharge control unit is driven with a driving waveform for which consumption of the liquid per unit time is smaller than that of the printing toward an printing medium to the pressure generating unit.

4. The control apparatus according to claim 1, wherein the discharge control unit controls a supply pump that is connected to the flow passages of the liquid ejecting head and supplies the liquid so that the liquid within the flow passages is discharged from the nozzle opening.

5. The control apparatus according to claim 1, wherein the discharge control unit controls an absorbing unit that absorbs the liquid from the nozzle opening of the liquid ejecting head so that the liquid within the flow passages is discharged from the nozzle opening.

6. A liquid ejecting apparatus comprising:
a control apparatus comprising a discharge control unit, wherein the discharge control unit controls liquid so that, before a start of printing of which the printing is performed on a printing medium by ejecting a liquid, which is filled and heated within flow passages, from a nozzle opening, the liquid within the flow passages of the liquid ejecting head is discharged from the nozzle opening, and, after the liquid ejecting head is heated to a printing temperature by the heated liquid and the liquid ejecting head reaches the printing temperature, discharging of the liquid from the nozzle opening is stopped;
a liquid ejecting head that ejects the liquid from the nozzle opening; and
a heating unit that heats the liquid flowing within the flow passages of the liquid ejecting head.

7. The liquid ejecting apparatus according to claim 6, wherein the heating unit is disposed in the liquid ejecting head.

8. The liquid ejecting apparatus according to claim 6, wherein the heating unit is disposed in a liquid storing section in which the liquid supplied to the liquid ejecting head is stored.

9. The liquid ejecting apparatus according to claim 6, wherein the discharge control unit is disposed within the liquid ejecting head and a pressure generating unit that generates pressure change within the flow passages and ejects the liquid from the nozzle opening is driven, so that the liquid within the flow passages is discharged from the nozzle opening.

10. The liquid ejecting apparatus according to claim 9, wherein the discharge control unit is driven with a driving waveform for which consumption of the liquid per unit time is smaller than that of the printing toward an printing medium to the pressure generating unit.

11. The liquid ejecting apparatus according to claim 6, wherein the discharge control unit controls a supply pump that is connected to the flow passages of the liquid ejecting head and supplies the liquid so that the liquid within the flow passages is discharged from the nozzle opening.

12. The liquid ejecting apparatus according to claim 6, wherein the discharge control unit controls an absorbing unit that absorbs the liquid from the nozzle opening of the liquid ejecting head so that the liquid within the flow passages is discharged from the nozzle opening.
